(19) United States
(12) Patent Application Publication
(10) Pub. No.: US 2023/0111345 A1
(43) Pub. Date: Apr. 13, 2023

(54) IMAGE PROCESSING OF MICROSCOPY IMAGES IMAGING STRUCTURES OF A PLURALITY OF TYPES

(71) Applicant: Carl Zeiss Microscopy GmbH, Jena (DE)

(72) Inventors: Manuel AMTHOR, Jena (DE); Daniel HAASE, Zöllnitz (DE)

(73) Assignee: Carl Zeiss Microscopy GmbH, Jena (DE)

(21) Appl. No.: 17/952,684

(22) Filed: Sep. 26, 2022

(30) Foreign Application Priority Data
Oct. 1, 2021 (DE) 102021125512.0

(51) Int. Cl. G06T 7/00; G06V 10/32; G06V 20/50; G06T 7/168; G06V 10/762

(52) U.S. Cl. CPC G06T 7/0012; G06T 7/168; G06V 10/32; G06V 10/762; G06V 20/50; G06T 2207/10056; G06T 2207/20084; G06T 2207/30024

(57) ABSTRACT

Various examples relate to techniques for the image processing of microscopy images which image a plurality of types of a structure. The plurality of types have different appearances.

### TECHNICAL FIELD

Various examples of the invention relate to techniques for evaluating light-microscope images.

### BACKGROUND

Image processing algorithms are used within the scope of processing/evaluating recorded microscopy images. By way of example, machine-learned image processing algorithms are often used. Specific applications for the processing for example comprise an artefact reduction, noise suppression, resolution increase, recognition of objects and output as segmentation masks or a classification of an image content according to in principle any classification criteria. In the examination of cell cultures, it is often necessary to quantify specific properties of the sample. By way of example, it may be necessary to determine an estimation of the number of cells or to determine an estimation of a degree of confluence of the cells (i.e., the proportion of the cell-covered sample surface). In the case of semiconductor structures, image processing algorithms can be used to recognize and optionally classify defects.

### SUMMARY

Therefore, there is a need for improved techniques for the processing of microscopy images.

This object is achieved by the features of the independent patent claims. The dependent claims define embodiments.

A computer-implemented method for processing a microscopy image comprises obtaining a microscopy image. The microscopy image images a plurality of types of a structure. The plurality of types have a different appearance in the microscopy image in relation to a structure property. The method further comprises, for each of the plurality of types: in each case adjusting an image property of the microscopy image in order to obtain a corresponding normalized representation of the microscopy image, in which the structure of the respective type has an appearance in relation to the structure property that corresponds to a given reference value. Moreover, the method comprises the application of an image processing algorithm on the basis of the plurality of normalized representations of the microscopy image.

A computer program or a computer program product or a computer-readable storage medium comprise program code. The program code can be loaded and executed by a processor. This causes the processor to carry out a method for processing a microscopy image. The method comprises obtaining a microscopy image. The microscopy image images a plurality of types of a structure. The plurality of types have a different appearance in the microscopy image in relation to a structure property. The method further comprises, for each of the plurality of types: in each case adjusting an image property of the microscopy image in order to obtain a corresponding normalized representation of the microscopy image, in which the structure of the respective type has an appearance in relation to the structure property that corresponds to a given reference value. Moreover, the method comprises the application of an image processing algorithm on the basis of the plurality of normalized representations of the microscopy image.

A device for processing a microscopy image comprises a processor. Said device is configured to obtain a microscopy image. The microscopy image images a plurality of types of a structure. The plurality of types of the structure have a different appearance in the microscopy image in relation to a structure property. The processor is furthermore configured to, for each of the plurality of types, in each case adjust an image property of the microscopy image in order to obtain a corresponding normalized representation of the microscopy image, in which the structure of the respective type has an appearance in relation to the structure property that corresponds to a given reference value. Moreover, the processor is configured to apply an image processing algorithm on the basis of the plurality of representations of the microscopy image.

The features set out above and features that are described below can be used not only in the corresponding combinations explicitly set out, but also in further combinations or in isolation, without departing from the scope of protection of the present invention.

### BRIEF DESCRIPTION OF THE FIGURES

FIG. 1 schematically illustrates the adjustment of a microscopy image according to various examples.

FIG. 2 schematically illustrates the processing of a normalized representation of the microscopy image from FIG. 1, according to various examples.

FIG. 3 schematically illustrates a device according to various examples.

FIG. 4 is a flowchart of an exemplary method.

FIG. 5 illustrates a microscopy image which images a plurality of types of cells according to various examples.

FIG. 6 is a flowchart of an exemplary method.

FIG. 7 illustrates a density map for the microscopy image from FIG. 5 according to various examples.

FIG. 8 illustrates the data processing for the image processing of a microscopy image according to various examples.

FIG. 9 illustrates a microscopy image and a plurality of normalized representations of the microscopy image according to various examples.

### DETAILED DESCRIPTION OF EXAMPLES

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs denote identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to the person skilled in the art. Connections and couplings between functional units and elements as illustrated in the figures can also be implemented as an indirect connection or coupling. A connection or coupling can be implemented in a wired or wireless manner. Functional units can be implemented as hardware, software or a combination of hardware and software.

Techniques for digital and automated processing of microscopy images of a sample and/or a sample environment (for instance, a sample holder) are described below.

The microscopy images can image various structures. By way of example, the microscopy images could image cells; the techniques described herein could be used to examine cell cultures, for example, that is to say it could be possible to quantify properties of the cells or cell cultures, for example. However, other types of structures are also conceivable. By way of example, the microscopy images could image technical devices under test, for example semiconductor structures; in this way, it could be possible to recognize defects in the semiconductor structures. By way of example, the microscopy images could image optical devices under test and it could be possible to recognize and evaluate defects such as scratches or aberrations in the curvature of lenses. By way of example, the microscopy images could image material samples, for example substances or plastics surfaces, and defects or deviations from the standard could be identified. Structures represented in a microscopy image may be, for example, biological samples, cells or cell organelles, tissue sections, liquids, rock samples, electronics components, sample holders, sample holder supports or sections or constituent parts thereof. By way of example, the sample may comprise biological cells or parts of cells, material or rock samples, electronics components and/or objects received in a liquid. It could also be possible to image sample-non-specific structures, for example artefacts from microscopic imaging, for instance on account of overexposure or underexposure or on account of particles of dirt in the microscope.

In the various examples described herein, an image processing algorithm can be used to determine one or more properties — for instance position, number, class — of such structures or other structures.

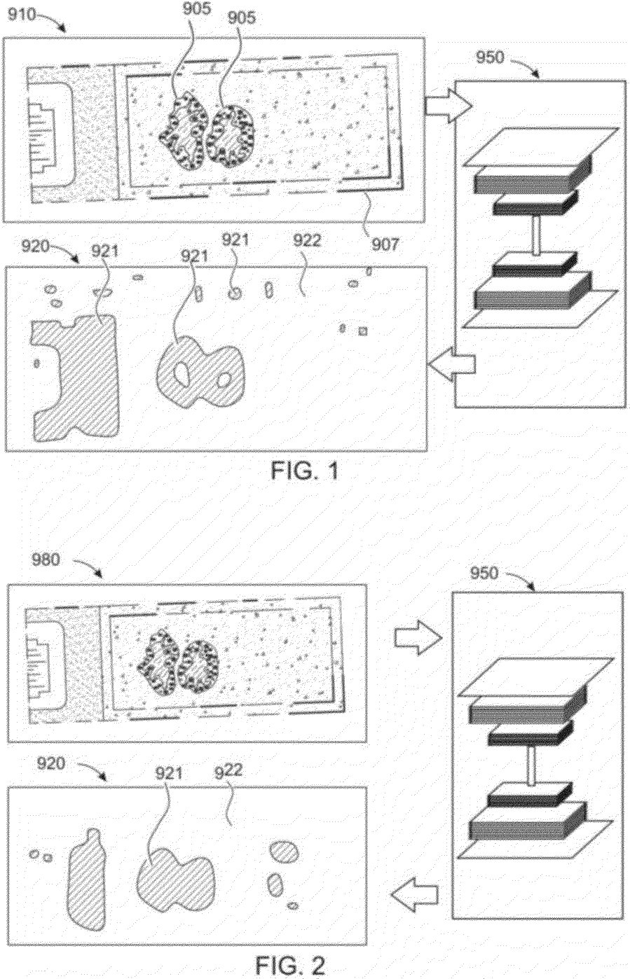

A fundamentally occurring problem in the context of image processing algorithms is explained with reference to FIGS. 1 to 4. FIGS. 1 to 4 elucidate aspects in conjunction with the use of an image processing algorithm 950.

FIG. 1 schematically shows a microscopy image 910, in which a sample holder 907 with a sample 905 are recognizable. The sample holder 907 in this case is a transparent object slide with a cover slip, between which biological cells are situated as sample 905. As illustrated, the sample holder 907 may comprise a text field and differently stained or differently transparent regions. Recognition and processing of the sample 905 from the microscopy image 910 can be made more difficult by contaminants, mirroring, irregular illumination properties or on account of a background being visible through the transparent object slide.

In FIG. 1, the microscopy image 910 is supplied to the image processing algorithm 950 as an input. In the example shown, the latter is a neural network, for example a CNN (convolutional neural network), which is trained to calculate a segmentation mask from an input image. However, this is only an example.

The image processing algorithm 950 calculates a segmentation mask 920 in which various objects are characterized by different pixel values. A certain pixel value specifies that corresponding pixels form a segmentation region 921 identified as a sample 905 while another pixel specifies a background 922. As is evident in FIG. 1, the segmentation mask 920 is faulty. A plurality of image regions which do not show a sample were incorrectly identified as segmentation regions 921 of a sample. Moreover, the segmentation regions 921 in fact corresponding to the sample 905 have holes in which the sample 905 was not recognized.

FIG. 2 elucidates a case in which the microscopy image 910 from FIG. 1 was rescaled, that is to say it was changed in terms of size (pixel number or image resolution) and a corresponding normalized representation 980 of the microscopy image 910 is obtained. Edge lengths of the normalized representation 980 are 65% of the edge lengths of the microscopy image 190. The normalized representation 980 is supplied to the image processing algorithm 950 as input. The image processing algorithm 950 in FIG. 2 is identical to the image processing algorithm 950 from FIG. 1. Nevertheless, the resultant segmentation mask 920 in FIG. 2 differs significantly from the segmentation mask 920 from FIG. 1. From this, it is evident that the scaling of the input image has a significant influence on the result of the image processing algorithm 950. The minor difference in the information content of the input images in FIG. 1 and FIG. 2 on account of the different image resolutions does not explain these results. To help explain this case, what can be considered is that the CNN implementing the image processing algorithm 950 comprises a plurality of convolution layers, in which e.g. a 3 x 3 matrix or a 5 x 5 matrix (the convolution kernel) is shifted over the respective inputs into the corresponding layer. The size of the 3 x 3 matrix relative to the imaging size of the sample 905 (e.g., the number of pixels of the diameter of the sample 905) has a significant influence on the result.

Phrased more generally, various examples described herein are based on the recognition that the appearance of a structure (e.g., the size like in the example of FIG. 1 and FIG. 2 or else also orientation or contrast, etc.) may have an influence on the result of the utilized image processing algorithms.

Therefore, techniques as to how an image property of a microscopy image can be adjusted in order to change the appearance of a structure such that the image processing algorithm supplies a better result are described herein.

In this case, the appearance of a structure in the microscopy image depends on at least the following two parameters: (i) imaging parameters of the microscope used to capture the microscopy image; and (ii) type of the structure.

Various examples of the invention are based on the further recognition that adjusting the image property while taking account of the two influences of (i) the imaging parameters and (ii) the type of the structure may be desirable.

By way of example, cells — as an example of structures taken into account — may appear to be larger or smaller in the microscopy image 910 depending on the magnification. Equally, the contrast of the cells in the microscopy image 910 may appear different depending on the utilized imaging modality - for example, bright field imaging or dark field imaging or phase contrast. The orientation of the cells may change depending on the orientation of the sample holder. In addition to such a variance in the appearance caused by the imaging parameters, different appearances may also be caused by different types of the examined structure. By way of example, there may be different types of cells, for instance living cells and dead cells. Dead cells may have a larger diameter than living cells. Hence, the appearance of the structure property “size” may vary for cells of the various types, that is to say dead cells may appear larger than living cells. Such a variance in the appearance of the structure may have a negative effect on the accuracy of the image processing algorithm 950, as made plausible above in FIG. 2 regarding the context of FIG. 1.

To improve the accuracy of the image processing algorithm 950 — also for various types of a structure — it is possible according to various examples for an image property of a microscopy image to be adjusted differently in each case for each type. By way of example, it could be possible to determine a plurality of entities of a microscopy image (e.g., by copying the microscopy image), with the plurality of entities being associated with a plurality of types of a structure imaged by the microscopy image. By way of example, an associated entity could be determined for each type. Then, an image property of the respective entity of the microscopy image can be adjusted for each entity of the microscopy image in order in this way to obtain a respective normalized representation of the microscopy image.

Various examples of image properties that can be adjusted are described below in the context of Table 1. The adjustment of the image properties influences an appearance of the structure in respect of structural properties of the sample correlating with this image property, as is also described below.

TABLE 1

Various examples of adjusting image properties of microscopy images in order to obtain representations normalized thus.

| | |
|---|---|
| Image property | Explanation |
| Size | By way of example, the microscopy image could be rescaled appropriately. A corresponding technique has been explained above in conjunction with the specific examples of FIG. 1 and FIG. 2 . What rescaling achieves is that the imaging size of the structures is adjusted in the normalized representations. This allows the appearance of the structure to be set in view of the “size” (more accurately: structure size) structure property. By way of example, smaller structures could be represented in enlarged fashion or larger structures could be represented in size-reduced fashion. Types of the structure that have different structural sizes may in this way be adjusted, individually in each case, in terms of their imaging size. This change in size or scaling may be implemented by any desired scaling method, for example by an interpolation such as a (bi-)linear, bicubic or a nearest neighbour interpolation. |
| Contrast | By way of example, the microscopy image could be suitably modified in respect of the contrast. By way of example, the contrast could be increased or reduced. This may change the appearance of the structure in respect of the “transparency” structure property or other structure properties that influence the contrast. Structures with a high transparency could be increased in terms of contrast, and vice versa. Types of the structure which have different structural transparency (or other parameters influencing the contrast) may thus be adjusted individually in terms of contrast. |
| Orientation | By way of example, the microscopy image could be changed in terms of the orientation, that is to say it could be rotated. This allows the appearance of the structure to be modified in view of the “alignment” structure property. By way of example, the alignment of ordered structures (for instance semiconductor components) in relation to the substrate could be given in the case of said structures, and the appearance in the microscopy image can then be changed by way of the rotation. Types of the structure that have different alignments can in this way be adjusted individually in terms of the orientation. |
| Brightness | By way of example, the microscopy image could be modified in respect of the brightness. Brightness properties of a structure can relate for example to a hue or greyscale value, a brightness, a saturation or an image contrast of the structures. Likewise, a distribution of the aforementioned characteristics may be comprised, for example a brightness distribution within a structure. This can change the appearance in respect of the “colour” structure property or other structure properties that influence the brightness. By way of example, some types of a structure could appear brighter than others on account of their colour. Types of the structure which have different colours (or other structure properties influencing the brightness) can thus be adjusted individually in terms of their brightness. |
| Distortion | The microscopy image could be adjusted in respect of the inclination/distortion. As a result, the appearance of compressed or stretched structures (for instance on account of a sample environment) can be adjusted in such a way that these appear de-compressed or de-stretched. A distortion may be caused by a “compression/stretching” structure property, etc., for instance because the sample was mounted in compressed fashion or an elastic sample is fastened differently to a sample holder, for instance a substance sample or an elastic film. |

These are only a few examples. Other examples are possible, for example shearing, image distortion, mirroring, hue value change or gamma correction. The adjustment can be implemented using an image adjustment program. By way of example, the image adjustment program could comprise a machine-learned conversion algorithm. However, manually parameterized image adjustment programmes would also be conceivable. In principle, techniques for carrying out such adjustments are known, and so no further details have to be specified here in respect of the specific implementation.

In the respective normalized representation, the structure (e.g., a cell) of the respective type (e.g., dead cells) thus has an appearance (e.g., imaging size) in relation to the considered structure property (e.g., size) which corresponds to a given reference value.

The reference value may be chosen such that the image processing algorithm supplies particularly good results. By way of example, this could be tested empirically. The reference value could also be determined by training the image processing algorithm. Expressed differently, this means that the structure can have an appearance (i.e., for instance imaging size, contrast, etc.) in the normalized representation (at least in relation to the considered structure property, i.e., for instance size, transparency, etc.) that is closer to the corresponding appearance in training images.

This thus means that the adjustment of image properties for each type can be implemented specifically for the respective associated type of the structure. By way of example, cells (an example of sample structures) of different types could be present and the different cell types can have different sizes. It would then be possible for rescaling (cf. Table 1) to be implemented, with a different scaling factor being used depending on the associated cell type. What this can achieve is that the imaging size of the respective cell type corresponds to a given size reference value in the normalized representations of the microscopy image. By way of example, all cell types could be normalized to the same size reference value. However, it would also be possible to use different size reference values for different cell types.

Should the normalized representations have been obtained for the various types of the structure, the image processing algorithm can be applied on the basis of the plurality of normalized representations. By way of example, the normalized representations may serve directly as input images for the image processing algorithm or the normalized representations can also be processed further before the image processing algorithm is applied.

In summary, such techniques thus allow the duplication of a microscopy image to form a plurality of entities prior to the entry into the image processing algorithm and then the adjustment of these pluralities of entities such that the appearance of represented structures becomes more similar to that of the employed training data. The reliability of correct image processing is increased with greater similarity to the training data.

As a result of using normalized representations for the plurality of types of the structure, it is possible to improve the accuracy of the image processing algorithm. By way of example, it was observed that the accuracy often is particularly high when the reference value of the appearance for the respective structure property corresponds to a value used for training images during training, that is to say the same imaging size and/or orientation and/or the same contrast etc. as in the training images is used. However, by virtue of also taking account of dependencies of the appearance on account of different structure properties for different types of the structure, it is possible overall to obtain more accurate image processing.

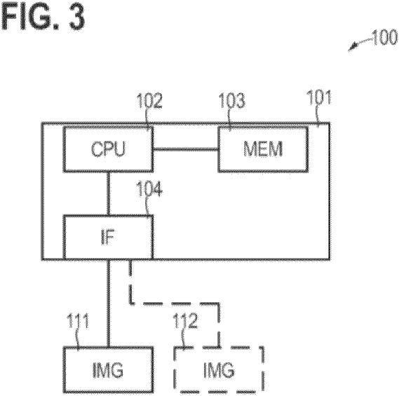

FIG. 3 schematically illustrates a system 100 in accordance with various examples. The system 100 comprises a device 101. The device 101 serves for processing microscopy images. The device 101 could be for example a computer or a server. The device 101 comprises a processor 102 and a memory 103. The device 101 also comprises an interface 104. Via the interface 104, the device 101 can receive image data, for example microscopy images, from one or more imaging devices 111, 112. The processor 102 could also transmit control data via the interface 104 to said one or more imaging devices 111, 112 in order to drive the latter for capturing image data. By means of the control data, the processor 102 could also set the values of one or more imaging parameters, for example illumination parameters.

The device 101 can physically be part of a microscope, can be arranged separately in the microscope surroundings or can be arranged at a location at any distance from the microscope. The device 101 can also have a decentralized design. In general, the device 101 can be formed by any combination of electronics and software and, in particular, comprise a computer, a server, a cloud-based computing system or one or more microprocessors or graphics processors. The device 101 can also be set up to control the sample camera, the overview camera, the image recording, the sample stage control and/or other microscope components.

Put generally, the processor 102 can be configured to load control instructions from the memory 103 and to execute them. When the processor 102 loads and executes the control instructions, this has the effect that the processor 102 performs techniques such as are described herein. Such techniques will include for example driving the imaging device 111 and optionally the imaging device 112 in order to capture microscopy images. For example, the processor 102 could be configured to control the imaging device 111 in order to capture one or more microscopy images of a sample by means of microscopic imaging. The processor 102 may be configured to carry out an image processing algorithm such as the image processing algorithm 950. The processor 102 may be configured to adjust a microscopy image multiple times, specifically in each case for each of a plurality of types of a structure; an image adjustment program may be carried out to this end. The processor 102 may be configured to determine one or more normalized representations by way of the image adjustment program.

The image adjustment program converts an image by virtue of adjusting one or more of the aforementioned image properties, that is to say for example brightness, contrast, orientation, size. An image content of a microscopy image may otherwise remain unchanged. By way of example, the image adjustment program changes the “size” image property on the basis of the size of represented structures without necessarily carrying out further processings. A normalized representation is obtained in this way.

In principle, it is possible to use different imaging modalities for the microscopy images to be evaluated in the examples described herein. Said different imaging modalities can be implemented by one or more imaging devices such as the imaging devices 111, 112. Exemplary imaging modalities relate for example to transmitted light contrast (without fluorescence). For example, a phase contrast, in particular, could be used. A wide field contrast could be used. A bright field contrast could also be used. A further imaging modality provides a fluorescence contrast.

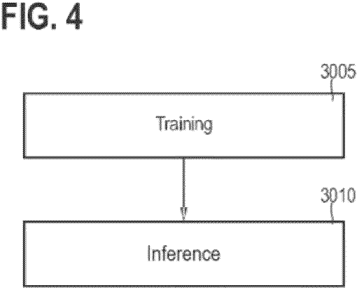

FIG. 4 is a flowchart of one exemplary method. For example, the method from FIG. 4 could be carried out at least partly by the processor 102 of the device 101. FIG. 4 illustrates aspects in the context of different phases of processing of microscopy images.

One or more ML algorithms/ML models are trained in box 3005. The one or more ML algorithms can be used within the scope of an image processing algorithm for processing or analysis of microscopy images, for example in order to determine an estimation of the number and/or of the degree of confluence of the imaged cells. The one or more algorithms could also be used in the context of an image adjustment program which adjusts a microscopy image, for example scales, rotates, changes the brightness, etc.

Parameters values of corresponding ML algorithms are thus determined in the context of the training. This can be done by way of an iterative optimization that maximizes or minimizes a specific target function, taking account of training data — i.e., training microscopy images — which are assigned prior knowledge or ground truth in the form of labels. By way of example, techniques of backward propagation could be used in association with ANNs. A gradient descent method can be used here in order to set weights of the different layers of the ANNs.

The training microscopy images (training images for short) image structures with a certain appearance in relation to a structure property. By way of example, cells could be imaged with a certain imaging size as sample structures, correlating with the “size” structure property. In the case of technical ordered sample structures, for instance semiconductor components, the semiconductor elements with a certain orientation could be imaged, correlating with the “alignment” structure property. Corresponding dependencies were discussed in Table 1.

The labels can correspond to a desired output of the respective ML algorithm. Thus, the labels can vary depending on the use of the ML algorithm. For example, the scaling factor, or the rescaled image, could be specified as a label for an image conversion program; by way of example, the number of cells or e.g. a density map (on the basis of which the number of cells can be determined) could be specified as a label for an image processing algorithm. The labels can be allocated manually by experts. However, it would also be conceivable for labels to be generated automatically. To this end, additional image contrasts, for example fluorescence contrast, or an electron microscope recording, can be used; further information, for instance reliably the cell nucleus position for cells, can be derived from such additional image contrasts. Such additional image contrasts can be available exclusively during the training.

The application of the one or more ML algorithms trained in box 3005 then takes place in box 3010. This means that estimates are determined for certain observables -without prior knowledge.

By way of example, a scaling or a rotation of a microscopy image could be carried out by way of an image adjustment program.

By way of example, an estimation of the number of cells and/or an estimation of the degree of confluence of the cells can be determined on the basis of a light-microscope image using an image processing algorithm. Defects in technical structures could be recognized on the basis of an image processing algorithm. Optical aberrations in optical devices under test could be recognized.

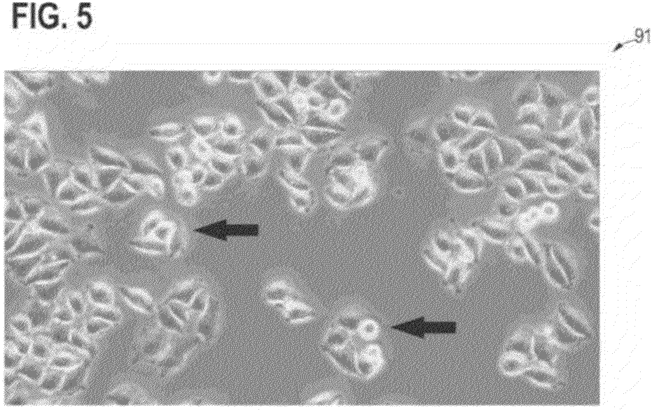

The training and/or the processing in box 3005 and box 3010, respectively, can each take account of a plurality of types of a certain imaged structure. The training may be carried out separately for training images that image a respective type of the structure. By way of example, a plurality of evaluations could be carried out for a plurality of structures. The different appearances of different types of a structure are illustrated in exemplary fashion for cells in FIG. 5. FIG. 5 illustrates an exemplary microscopy image 91. Cells are visible. In particular, cell types are visible, namely living cells and dead cells. The two types of cells are each marked by an arrow. It is evident in FIG. 5 that the different cell types may have different sizes.

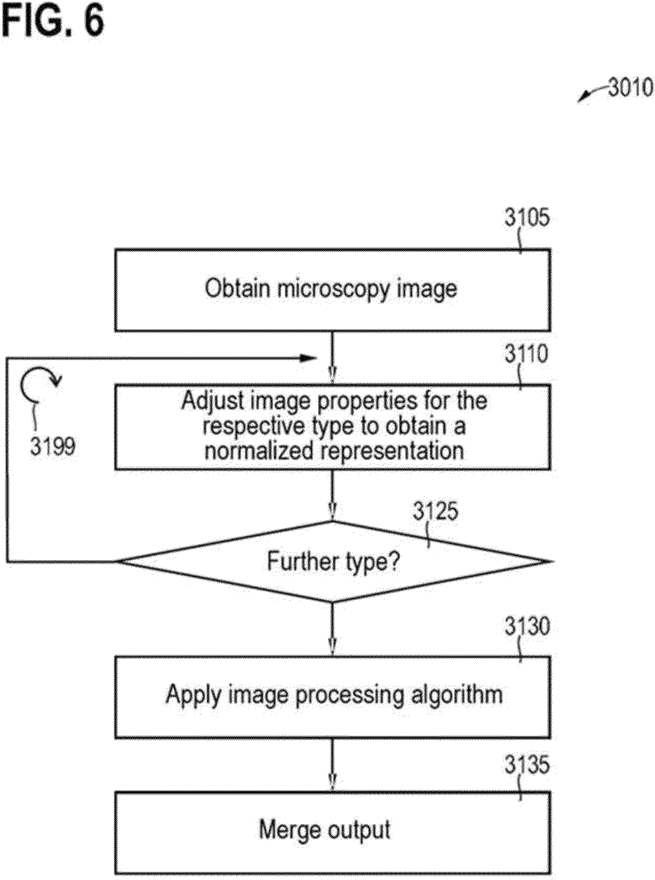

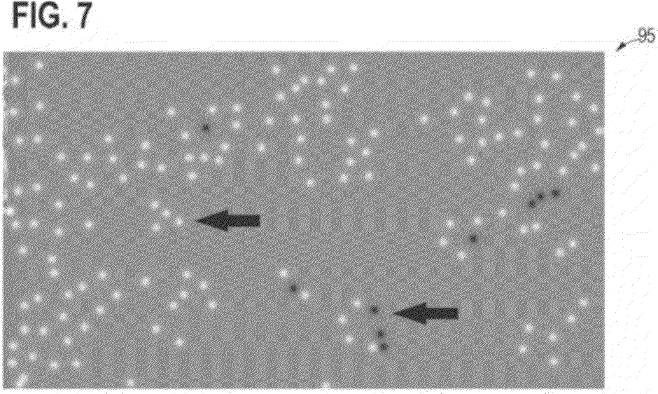

FIG. 6 is a flowchart of one exemplary method. By way of example, the method from FIG. 6 could be carried out by a processor on the basis of program code loaded from a memory. By way of example, the method from FIG. 6 could be executed by the processor 102 (cf. FIG. 3). The method from FIG. 6 relates to the inference, and could therefore implement box 3010 from FIG. 4.

A microscopy image is obtained in box 3105. By way of example, an image sensor of a microscope could be controlled to this end. It would also be conceivable for a microscopy image to be loaded from a database or generally from a memory.

In particular, a microscope can be understood to mean a light microscope, an x-ray microscope, an electron microscope or a macroscope.

The microscopy image images one or more structures. By way of example, the microscopy image could image a certain sample structure. The microscopy image could also image a structure of a sample holder. Structures could also relate to aberrations or reflections or interference particles.

In particular, a plurality of types of the structure can be imaged. The various types may differ in respect of their appearance in the microscopy image. This is due to the fact that one or more structure properties of the structure are different for the various types. By way of example, the appearance of the structure could differ for the various types on account of the “size” structure property, that is to say the types could be imaged with different sizes. Alternatively or in addition, the appearance of the structure could differ for the various types on account of the “transparency” structure property, that is to say the different types could be imaged with a different contrast.

Then, a loop 3199 is run through for each of the plurality of types.

Then, the microscopy image is adjusted accordingly for each type in box 3110 and a corresponding normalized representation of the microscopy image is obtained in this way. This means that the number of normalized representations of the microscopy image obtained equals the number of implemented iterations of the loop 3199. At the same time, each normalized representation is associated with a corresponding type.

Box 3110 may comprise a plurality of partial steps. By way of example, the occurrence of the respective type of the current iteration of the loop 3199 can be recognized. An image adjustment parameter value could be determined before or thereafter, the image adjustment parameter value being used to adjust the microscopy image.

Thus, the occurrence of the respective type of the structure can in particular be recognized in different image portions of the microscopy image in box 3110. Expressed differently, this means that the type can be localized in the microscopy image. The different types can be arranged in different image portions of the microscopy image. By way of example, in different image portions of the microscopy image the different types can be dominant, that is to say occur predominantly, in comparison with other types.

As a general rule, a variety of techniques can be used to determine image portions which are associated with a specific type. Some exemplary techniques are described below in association with Table 2.

TABLE 2

Various techniques for localizing types of a structure in the microscopy image or recognizing corresponding image portions.

| | |
|---|---|
| Object recognition | It is possible to determine the one or more image portions on the basis of object recognition. Structures of the respective type are arranged in the one or more image portions. A suitable object recognition algorithm can be used for the object recognition. By way of example, said algorithm could be machine-learned. It would be possible to search for certain textures or shapes. By way of example, known types of cells could be localized or detected. Such a use of the object recognition can be helpful, in particular, if the object recognition can be carried out more robustly on the not yet adjusted microscopy image than the image processing algorithm. Specifically, this allows the use of a generically trained object recognition algorithm to robustly recognize the various structures. The object recognition could use the appearances of the plurality of types as prior knowledge. For example, it would be conceivable for prior knowledge about the imaging size of different cell types to be available. For example, such prior knowledge could be obtained by means of a user input. It would also be conceivable for such prior knowledge to be determined on the basis of the microscopy image, for example on the basis of properties of the imaging modality, for example on the basis of a magnification factor. In other examples, it would also be conceivable, however, for the object recognition to have no prior knowledge about the various types. Such a scenario can be helpful particularly if the number of different types is not fixedly predefined from the outset or remains open. |
| Image-to-image transformation | By way of example, a machine-learned algorithm could be applied to the microscopy image. This algorithm can output an image adjustment parameter value for the adapting continuously or discretely, for each pixel. This corresponds to an image-to-image transformation. It would then be possible to smooth this image adjustment parameter value. |
| Clustering algorithm | It would also be possible to determine the one or more image portions using a clustering algorithm. The clustering algorithm can be trained by unsupervised learning. Said algorithm can determine clusters associated with corresponding appearances of the plurality of types of the structure. By way of example, a machine-learned algorithm which encodes the microscopy image could be used. An encoding branch is able to encode spatial domain features, that is to say successively reduce a spatial resolution. Then, the clusters could be determined on the basis of a distance of latent feature representations of the result of the coding in the feature space. It would be possible to use latent feature representations of a CNN pixel-or batchwise, for example. The clusters could also be determined for example on the basis of a segmentation of contrast values of the microscopy image. This means that a segmentation mask can be determined on the basis of contrast values; the corresponding segments can then be clustered. The clusters could also be determined on the basis of the output of an image-to-image transformation in accordance with the preceding example in this table. That means that clusters of a corresponding adjustment parameter that can be determined pixelwise can be ascertained. In some scenarios it would be conceivable for prior knowledge about the number of types reproduced in the microscopy image to be available. It would then be possible for the number of types to be predefined as a boundary condition of the clustering algorithm. By way of example, a k-means algorithm could be used if prior knowledge about the types in the microscopy image is available. Example: The permissible scaling factors are known. In such examples, the number of types is defined. However, it would also be possible for prior knowledge about the appearance not to be available. The number of clusters can then be determined dynamically. A latent Dirichlet allocation algorithm could be used. |
| Segmentation of contrast values | By way of example, it would be possible for contrast values of the microscopy image to be segmented. Then, the image portions can be determined on the basis of this segmentation. This could be combined for example with morphological operators, e.g., island filtering, edge smoothing, etc. In this way it would be possible to distinguish between different types of the structure. Contrast threshold operators could be used to distinguish between the different types of the structure. |

These techniques could also be combined and corresponding results for the image portions could be averaged. It would be possible for the image portions to be provided by a segmentation of the microscopy image. In the process, however, there may also be segments which denote for example image background, that is to say have no structures of a corresponding type. The image portions could also be provided in list form, for example in the form of polygonal lines that outline a corresponding portion. In the described examples of Table 2, image portions associated with a respective type are determined on the basis of the microscopy image. However, it would in principle also be possible for corresponding techniques to be applied to the normalized representations. Then, an object recognition or a clustering algorithm, for example, can be carried out following an image adjustment.

A description is given below of an exemplary technique for determining a number of the types and optionally a localization of the types in the microscopy image. This exemplary implementation uses in particular a combination of the techniques from Table 2. For this purpose, a map describing the occurrence of the types of the structure in the microscopy image can be segmented. The map can thus indicate, for various image positions of the microscopy image, whether in each case a specific type appears there. The result of the segmentation can then indicate a plurality of portions in which a type appears, is dominant or is encountered exclusively.

A variety of techniques can be used here in order to determine such a map as input for the segmentation. In a variant, it would be possible to use an object recognition algorithm that marks concrete positions of the different types in the microscopy image, i.e. for example in each case the midpoint of an entity of the type. In this case, the object recognition algorithm could have recourse to prior knowledge concerning the appearance of the respective type in the microscopy image. For example, an imaging size of different cell types in the microscopy image could be concomitantly provided as prior knowledge (for instance on the basis of a known structure size and a known magnification factor of the imaging modality). For example, a geometric shape of the different cell types could be concomitantly provided as prior knowledge. However, such prior knowledge is not required in all variants. Sometimes, the object recognition algorithm could also itself ascertain the occurrence of different types, i.e., recognize a priori unknown classes or types. The object recognition algorithm could itself determine the imaging size of a type or the geometric shape in the microscopy image, for example. A further example for the determination of such a map would be the use of a clustering algorithm. The clustering algorithm can recognize the frequent occurrence of characteristic signatures without specific training, wherein said frequent occurrence can then be associated in each case with the presence of a specific type. On the basis of the clustering algorithm, the occurrence of a type can be determined in each case in the spatial domain and is then marked in the map. The clustering algorithm in turn can operate on a variety of inputs. For example, the clustering algorithm could use as input an image adjustment parameter value determined for the different pixels of the microscopy image or patchwise on the basis of an image-to-image transformation. Clusters can then be recognized in the spatial domain. The image-to-image transformation can then be carried out using a machine-learned algorithm. In this way, for example, a scaling factor could be predicted locally. Said scaling factor could vary from pixel to pixel, for example, and the clustering could then correspondingly identify in each case clusters of comparable scaling factors. A further example for an input into the clustering algorithm could be determined for example on the basis of the activities of an artificial neural network, i.e. could be obtained on the basis of the values of a latent feature vector of a machine-learned algorithm. In detail, an encoding branch could be used in order to encode in each case pixels or patches of the microscopy image. In this way, a latent feature vector is obtained for each pixel or patch. The different entries of the feature vector correspond to the probability of the occurrence of a respective type of the structure in the pixel or patch considered. For example, activities for a plurality of pixels or patches could then correspondingly be combined in order to form the map in this way. Yet another example for the input into the clustering algorithm concerns the use of a segmentation on the basis of contrast values. By way of example, segments of comparable contrast values of the microscopy image could in each case be determined. Foreground can be separated from background in this way. With the clustering algorithm, it would then be possible to search for clusters of comparable signatures in a targeted manner in the foreground region; however, it would also be possible already to form clusters directly in a structure-based manner without division into foreground and background (i.e. not to individually check each intensity value in the microscopy image, but rather for patches of the microscopy image on the basis of the structures). The last-mentioned variant would be advantageous if there is no background at all in the image, e.g. if the confluence of cells is 100%.

From what was stated above, it is evident that it is possible for the segmentation to in each case provide the portions in which a certain type occurs, dominates or is exclusively found. However, information specifying the specific position of the various entities of the type in the respective portion need not yet necessarily be obtained by means of the segmentation. Such a specific localization could be determined in a subsequent object recognition or in other suitable algorithms.

Further, an image property of the microscopy image is adjusted in box 3110 in order to obtain a corresponding normalized representation. The adjustment may relate to different image properties. Various examples were described above in the context of Table 1.

An image adjustment program can be used. By way of example, the image adjustment program may comprise a learned model for determining imaging properties of the structures of the respective type. An image adjustment parameter could be determined directly.

The image adjustment program could be integrated with an algorithm from Table 2 for localizing the types. By way of example, an algorithm from Table 2 could output an image adjustment parameter value for an image portion associated with the corresponding type, the image adjustment parameter value being used by the image adjustment program.

Then, the respective image property (e.g., image size) can be adjusted on the basis of a certain imaging property (e.g., the imaging size of the structure) such that the normalized representation is obtained, within the scope of which the structure of the respective type has an appearance (e.g., image size) which corresponds to a given reference value in relation to the corresponding structure property (e.g., structure size). On the basis of images, such a learned model can be trained within the scope of training to ascertain imaging properties of structures in the microscopy image. By way of example, the model can be designed as a CNN which is trained to determine a size of biological cells in entered images. The learned model for determining imaging properties is independent of the image processing algorithm (box 3130). Likewise, the training procedures of the image processing algorithm and of the image adjustment program are independent, for example use can be made of different training images.

There need not necessarily be an intermediate step in which the appearance of the structure is explicitly determined and output in relation to a certain structure property (e.g., transparency, size, alignment, etc.). Especially in the case of a learned model as part of the image adjustment program, it may be sufficient to carry out the conversion of the microscopy image on the basis of image properties of certain structures without having to explicitly state the appearance. By way of example, the image adjustment program may comprise a learned model for image conversion, which is learned using training images (cf. FIG. 4: box 3005), for which the label specifies how these training images should be converted. By way of example, microscopy images can be entered within the scope of the training, with a scaling factor being given as a target or annotation for each of these images. In this way, the model learns how to calculate a scaling factor for a microscopy image not seen during training. In principle, the annotated scaling factor for the training images can be determined in any way: In a simple case, a plurality of scaling factors are applied to a training image to this end, in order to calculate differently scaled images which are subsequently supplied to the image processing algorithm in each case. Results of the image processing algorithm are assessed (manually or automatically). The scaling factor of the image for which the result with the best assessment was obtained is now used as annotation for the training image. An analogous procedure can be carried out for other image properties, for example in order to determine an angle of rotation in place of or in addition to the scaling factor, or e.g. a change in the brightness, the contrast, etc. (cf. Table 1).

It would be possible for the image adjustment program to test a plurality of potential adjustments for the purposes of ascertaining a suitable adjustment of the microscopy image. In the process, different adjustments (e.g., different scaling factors, different rotations, different changes in contrast, etc.) are applied in order to generate potential normalized representations as inputs for the image processing algorithm. Then, image properties of structures in these normalized representations are assessed according to a specified criterion. The potential input image with the best assessment is selected as input image.

A check is carried out in box 3125 as to whether a further iteration of the loop 3199 is required for a further type of the structure. By way of example, the number of types could be specified such that a further iteration of the loop 3199 is carried out in box 3120 until the specified number of types is reached. However, it would also be possible for the number of types to be determined dynamically, for example on the basis of a result of an object recognition algorithm or a clustering algorithm, as described above in the context of Table 2. This means that, for example, the number of clusters can be checked and the loop 3199 is run through an according number of times. The number of recognized object classes can be used to determine the number of iterations of the loop 3199.

In this case, e.g. a clustering algorithm already carried out once, which already recognizes corresponding clusters for all types, need not be carried out again in each iteration. This also applies to other algorithms according to Table 2.

Then, the image processing algorithm can subsequently be applied in box 3130 on the basis of the normalized representations of the microscopy image.

The image processing algorithm can be designed for in principle any type of image processing and can output e.g. at least one result image, a one-dimensional number or a classification as image processing result, depending on the design. By way of example, the image processing algorithm comprises a learned model for image processing which, on the basis of the input image, calculates an image segmentation, a detection, a classification, an image improvement, a reconstruction of image regions or an image-to-image mapping, in particular. An image-to-image mapping can be, in particular, what is known as “virtual staining”, with a representation that is similar to a different imaging modality being produced; by way of example, a result image similar to a DIC image (differential interference contrast image) can be calculated from a DPC image (differential phase contrast image) as input image. A one-dimensional number can be e.g. a number of counted objects, which for example is the case when the image processing algorithm is configured to count biological cells or cell organelles within an image. In a classification, the input image is divided into one of a plurality of given classes. By way of example, the classes may specify a sample holder type or a sample type, or a quality assessment for the input image, for example whether the latter appears suitable for further image processing. An image improvement/artefact reduction could be implemented, for example a reduction in the image noise, a deconvolution, a resolution increase, or a suppression of interfering image contents (e.g., lustre points, dust particles, etc.). The reconstruction of image regions can in particular be understood to mean that defects in the input image are filled. By way of example, defects may arise by concealments or disadvantageous illuminations.

There are different options for implementing box 3130 in respect of the plurality of normalized representations which are associated with the different types of the structure. Some examples are described below in the context of Table 3.

TABLE 3

Various options of applying the image processing algorithm on the basis of the normalized representations.

| | | |
|---|---|---|
| | Implementation | Exemplary details |
| I | Downstream discarding of, in each case, non-relevant result components | By way of example, it would be conceivable for the image processing algorithm to be applied multiple times, specifically to each normalized representation of the microscopy image. It is then possible to discard such parts of an output of the image processing algorithm which are associated with image portions which are different than the respectively assigned one or more image portions. This therefore means that — phrased in general — parts of the result of the image processing algorithm, which relate to other types of the structure not associated with the respective normalized representation, are able to be discarded. This means that parts of the result not relevant to the respective type are discarded following the application of the image processing algorithm. |
| II | Spatially resolved application of the image processing algorithm | The image processing algorithm can be applied to the normalized representations, with however those image portions which are associated with the respective type of the structure being selectively taken into account. This therefore means that the image processing algorithm is not applied to those image portions which are not associated with the respective type of the structure. Thus, it is possible to avoid from the outset the determination of results for a different type of the structure, which is associated with the respective normalized representation. |
| III | Upstream masking of the normalized representation | It would be conceivable, for example, for such image portions which are not associated with the respective type of the structure to be masked out for each normalized representation. The image processing algorithm can then be applied to the respective normalized representation after the masking. What is achieved in this way is that the result of the image processing algorithm has no contributions which originate from image portions which are not associated with the respective type of the structure. Thus, it is possible to avoid from the outset the determination of results for a different type of the structure, which is associated with the respective normalized representations. |

The results of the application of the image processing algorithm in box 3130 can optionally be fused or merged in box 3135.

This means that the image processing algorithm can provide a respective output for each of the plurality of normalized representations, the output indicating one or more hidden properties of the respective type of the structure. These outputs can be merged in box 3135.

By way of example, it would be conceivable for the number of occurrences of the respective type of the structure, for example living cells or dead cells, to be counted in each case. This number of cells, or formulated more generally the number of the certain type of the structure, could then be combined to obtain an overall number. Thus, the partial results can be summated.

The aforementioned example of the number of structures of a certain type relates to a global hidden property for the entire image. The property is therefore sample-global. Then there can be a simple addition. However, local properties would also be conceivable, for example a degree of confluence or the positioning of the cells of the respective type for the cells. By way of example, it would be conceivable for the image processing algorithm to be applied to each of the plurality of normalized representations and for the respective output to comprise a density map. By way of example, a density map 95 determined for the microscopy image 91 from FIG. 5 is shown in FIG. 7. In this case, this density map 95 can encode a probability for the presence or for the absence of the cells of the respective type. The density map identifies the probability for the presence or absence of a cell by way of the contrast. In the density map 95 in accordance with the example illustrated, for this purpose, a predefined density distribution is centred in each case at the position of the geometric cell midpoint. By way of example, Gaussian bell curves (Gaussian kernel) could be used as predefined density distributions. It is evident from FIG. 7 that a full width at half maximum of the Gaussian bell curves is significantly smaller than the typical diameter of the cells. A local spatial domain integral over each of the Gaussian bell curves for the living cells can yield e.g. a value of 1. What can be achieved as a result is that the spatial domain integral over the entire density map 95 is equal to the number of cells. In any case the number of cells can be estimated on the basis of the spatial domain integral.

Especially in such a scenario, or else in other scenarios in which the output of the image processing algorithm is an image, it is therefore possible for the outputs provided by the image processing algorithm for each of the plurality of normalized representations to encode the one or more hidden properties of the structures of the respective type for different image positions in the microscopy image. The outputs can also be combined in image position-resolved fashion in such a case. By way of example, density maps could be averaged with spatial resolution.

What may optionally be taken into account in such image position-resolved combination is that the normalized representations were adjusted differently; thus, an inverse adjustment could be used so that the various image positions correspond to the same sample position. By way of example, the one back scaling could be carried out if the microscopy image was previously scaled multiple times in order to obtain the normalized representations.

Phrased in general: If the output of the image processing algorithm is a result image, a back transformation program can optionally carry out a conversion of the result image, which conversion is inverse to the conversion of the image adjustment program. Example: If a scaling factor of 0.4 is applied to the microscopy image (i.e., a reduction of the image size to 40% is brought about), the result image is rescaled by the inverse of the scaling factor (that is to say 1/0.4 = 2.5 in this example). If the microscopy image is rotated through an angle of rotation in the clockwise direction in order to produce the input image, the result image is rotated through the angle of rotation in anticlockwise fashion. These measures avoid a discrepancy between the image processing result and the original microscopy image which may impair further automated data processing under certain circumstances.

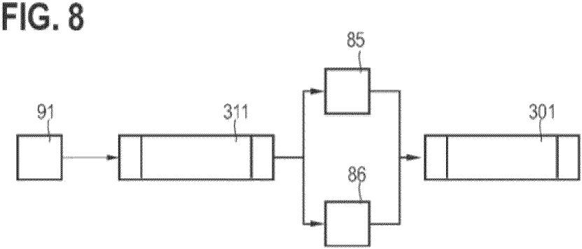

FIG. 8 illustrates aspects in the context of the data processing of a microscopy image. The data processing according to FIG. 8 could for example implement the method according to FIG. 6.

FIG. 8 illustrates that a microscopy image 91 (cf. also FIG. 1 and FIG. 5) is obtained and supplied to an image adjustment program 311 as an input.

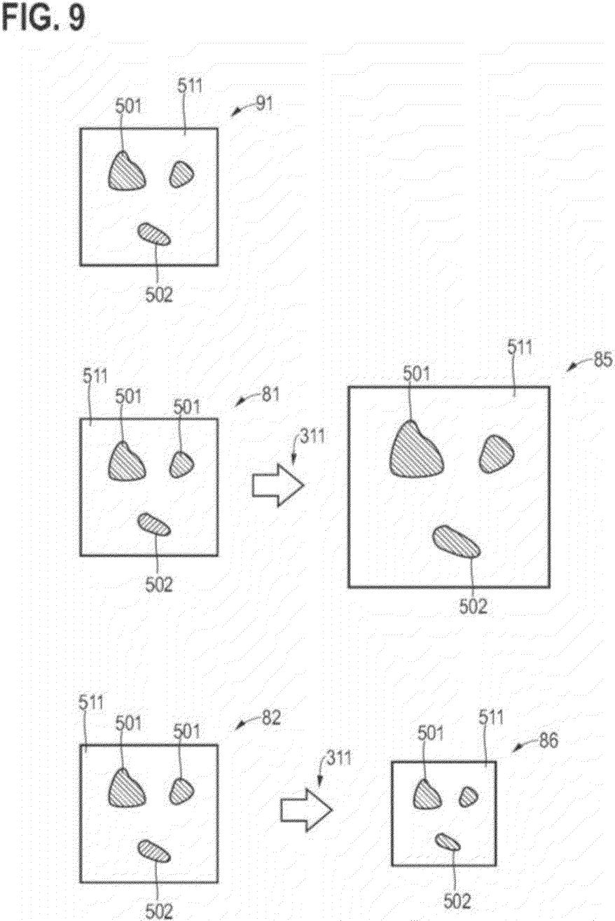

The image adjustment program 311 creates two normalized representations 85, 86 of the microscopy image (cf. FIG. 6: box 3125). This is also illustrated abstractly in the context of FIG. 9.

FIG. 9 illustrates a plurality of copies/entities 81, 82 of a microscopy image 91. The microscopy image 91 is illustrated schematically in FIG. 9. Moreover, different portions 501, 502 in which a respective type of a structure, for example a certain cell type, occurs dominantly are labelled in the microscopy image. Further, background 511 is also labelled.

Copies 81, 82 of the microscopy image 91 which are associated with the two types of the structure or the portions 501, 502 are determined accordingly. By way of example, the copy 81 is associated with the portions 501 and the copy 82 is associated with the portions 502.

FIG. 9 moreover illustrates the normalized representations 85, 86 for the two copies 81, 82. The normalized representations 85, 86 are obtained by scaling the copies 81, 82. In this case, different scaling factors are used, specifically such scaling factors that cause the respective type of the structure to have an imaging size in the respective normalized representations 85, 86 which corresponds to a given reference value. The given reference values could be the same or could be different for the different types, that is to say for the different copies 81, 82 (different scaling factors are used in FIG. 9). The given reference value could be chosen so that it corresponds to the imaging size of the corresponding type of the structure in training images when training an image processing algorithm. Particularly good results for the image processing algorithm can be obtained in this way.

Referring back to FIG. 8: it illustrates the image processing algorithm 301. By way of example, the image processing algorithm 301 can correspond to the image processing algorithm 950 from FIG. 1 and FIG. 2. The normalized representations 85, 86 serve as an input for the image processing algorithm 301. Various variants as to how this can be implemented were discussed in the context of Table 3. The application of the image processing algorithm corresponds to box 3130 from FIG. 6.

It goes without saying that the features of the embodiments and aspects of the invention described above can be combined with one another. In particular, the features can be used not only in the combinations described but also in other combinations or on their own without departing from the scope of the invention.

1. A computer-implemented method for processing a microscopy image, the method comprising:
obtaining a microscopy image imaging a plurality of types of one structure, with the plurality of types of the structure having a different appearance in the microscopy image in relation to a structure property,
for each of the plurality of types: in each case adjusting an image property of the microscopy image in order to obtain a corresponding normalized representation of the microscopy image, in which the structure of the respective type has an appearance in relation to the structure property that corresponds to a given reference value, and
applying an image processing algorithm on the basis of the plurality of normalized representations of the microscopy image.

2. The computer-implemented method according to claim 1,
wherein each type is associated with one or more image portions of the microscopy image, in which portions the respective type of the structure occurs or is dominant,
wherein the image processing algorithm is applied taking account of the corresponding one or more image portions.

3. The computer-implemented method according to claim 2,
wherein the image processing algorithm is applied to the normalized representations and those parts of an output of the image processing algorithm which are associated with different image portions to the respectively assigned one or more image portions are discarded in each case.

4. The computer-implemented method according to claim 2,
wherein the image processing algorithm is applied to the normalized representations, and
wherein the image processing algorithm is in each case applied selectively to the respective one or more image portions associated with the corresponding type.

5. The computer-implemented method according to claim 2, further comprising:
for each type: masking image regions other than the respective one or more image regions in the corresponding normalized representation prior to the application of the image evaluation algorithm to the respective normalized representation.

6. The computer-implemented method according to claim 2 , further comprising:
for each type: determining the respective one or more image portions on the basis of an object recognition of the plurality of types of the structure in the microscopy image.

7. The computer-implemented method according to claim 6,
wherein the object recognition uses the appearances of the plurality of types of the structure as prior knowledge.

8. The computer-implemented method according to claim 6,
wherein the object recognition predicts the appearances of the plurality of types of the structure.

9. The computer-implemented method according to claim 2 , further comprising:
for each type: determining the respective one or more image portions using a clustering algorithm.

10. The computer-implemented method according to claim 9,
wherein the clusters are determined on the basis of a distance of latent feature representations of a machine-learned encoding branch which encodes the microscopy image.

11. The computer-implemented method according to claim 9,
wherein clusters are determined on the basis of a segmentation of contrast values of the microscopy image or on the basis of an adjustment parameter determined pixel-by-pixel using an image-to-image transformation.

12. The computer-implemented method according to claim 9 ,
wherein a quantity of the plurality of types is given as a boundary condition of the clustering algorithm.

13. The computer-implemented method according to claim 2 further comprising:
each type: segmenting contrast values of the microscopy image, and
determining the one or more image portions on the basis of the segmentation.

14. The computer-implemented method according to claim 1 ,
wherein the image processing algorithm provides a respective output for each of the plurality of normalized representations, the output indicating one or more hidden properties of the respective type of the structure.

15. The computer-implemented method according to claim 14,
wherein the outputs provided by the image processing algorithm for each of the plurality of normalized representations encode the one or more hidden properties of the respective type of the structure for different image positions in the microscopy image,
the method further comprising:
combining the outputs in image position-resolved fashion.

16. The computer-implemented method according to claim 14,
wherein the outputs provided by the image processing algorithm for each of the plurality of normalized representations encode the one or more hidden properties of the structure as a sample-global parameter.

17. The computer-implemented method according to claim 1 ,
wherein the structure property comprises a size of the structures such that the different types of the structure appear in the microscopy image with different sizes, and
wherein the size of the microscopy image is adjusted in order to obtain the respective normalized representation such that the size of the respective type corresponds to a given size reference value.

18. The computer-implemented method according to claim 1 ,
wherein the structures are cells,
wherein the structure property is a size of the cells,
wherein the image property is a scaling of the microscopy image, and
wherein a quantity of the cells is determined as a sample-global parameter on the basis of an output of the image processing algorithm.

19. The computer-implemented method according to claim 18,
wherein the image processing algorithm is applied to each of the plurality of normalized representations and the respective output comprises a density map, the density map encoding a probability for the presence or absence of cells of the respective type.

20. The computer-implemented method according to claim 19, further comprising :
averaging the density maps in image position-resolved fashion.

21. The computer-implemented method according to claim 1 ,
wherein the appearance of the structure in respect of the structure property in the normalized representation is closer to an appearance of the structure in respect of the structure property in training images of the image processing algorithm.

22. A device for processing a microscopy image, the device comprising a processor configured to:
obtain a microscopy image imaging a plurality of types of one structure, with the plurality of types of the structure having a different appearance in the microscopy image in relation to a structure property,
for each of the plurality of types: in each case adjust an image property of the microscopy image in order to obtain a corresponding normalized representation of the microscopy image, in which the structure of the respective type has an appearance in relation to the structure property that corresponds to a given reference value, and
apply an image processing algorithm on the basis of the plurality of normalized representations of the microscopy image.

23. The device according to claim 22, wherein the processor is configured to for each type: mask image regions other than the respective one or more image regions in the corresponding normalized representation prior to the application of the image evaluation algorithm to the respective normalized representation .
